(19) United States
(12) Patent Application Publication
(10) Pub. No.: US 2022/0091464 A1
(43) Pub. Date: Mar. 24, 2022

(54) DISPLAY DEVICE AND METHOD FOR MANUFACTURING DISPLAY DEVICE

(71) Applicant: Japan Display Inc., Tokyo (JP)

(72) Inventors: Shunichi KIMURA, Tokyo (JP); Toshiharu MATSUSHIMA, Tokyo (JP)

(73) Assignee: Japan Display Inc., Tokyo (JP)

(21) Appl. No.: 17/477,556

(22) Filed: Sep. 17, 2021

(30) Foreign Application Priority Data
Sep. 18, 2020 (JP) 2020-157586

(51) Int. Cl. G02F 1/1343; G02F 1/1337

(52) U.S. Cl. CPC G02F 1/134309; G02F 1/133707; G02F 1/133788

(57) ABSTRACT

According to one embodiment, a display device includes a first substrate including a common electrode and a pixel electrode, a second substrate, a liquid crystal layer, a first alignment film and a second alignment film. The pixel electrode includes a plurality of branch portions extending in a first direction and a connection portion extending in a second direction, wherein the first alignment film and the second alignment film are photo-alignment films, and the first alignment film has an anchoring strength of 1*10⁻³J/m² or less.

### CROSS-REFERENCE TO RELATED APPLICATION

This application is based upon and claims the benefit of priority from Japanese Patent Application No. 2020-157586, filed Sep. 18, 2020, the entire contents of which are incorporated herein by reference.

### FIELD

Embodiments described herein relate generally to a display device and to a method for manufacturing the display device.

### BACKGROUND

A liquid crystal display device that operates in an in-plane-switching (IPS) mode or fringe field switching (FFS) mode is known as an example of a display device. In such a liquid crystal display device of a lateral electric field type, one of a pair of substrates opposed to each other across a liquid crystal layer interposed therebetween includes pixel electrodes and a common electrode. Liquid crystal molecules in the liquid crystal layer are driven by using an electric field generated between the pixel electrodes and the common electrode.

Recently, a liquid crystal display device utilizing a photo-alignment technology has been proposed. Hereinafter, an alignment film subjected to an alignment treatment (photo-alignment treatment) using the photo-alignment technique will be referred to as a photo-alignment film. The magnitude of an alignment regulating force in the photo-alignment film is defined as an anchoring strength.

### BRIEF DESCRIPTION OF THE DRAWINGS

FIG. 1 depicts an example of an equivalent circuit of a display device DSP.

FIG. 2 is a cross-sectional view of an example of the structure of the display device DSP.

FIG. 3 is a plan view of an example of a pixel PX.

FIG. 4 is a plan view of another example of the pixel PX.

FIG. 5 shows an aligned state of liquid crystal molecules LM1 of a positive type.

FIG. 6 shows an aligned state of liquid crystal molecules LM2 of a negative type.

FIG. 7 depicts an example of a method for manufacturing the display device DSP.

FIG. 8 depicts an example of an optical system 100 that measures twist angles φ₁ and φ₂.

FIG. 9 depicts a relationship between the voltage and the transmittance of the display device DSP in which liquid crystals of a negative type are used.

FIG. 10 depicts results of a first simulation.

FIG. 11 depicts results of the first simulation in which a liquid crystal material of a negative type is used.

FIG. 12 depicts results of a second simulation.

FIG. 13 depicts experimental results.

### DETAILED DESCRIPTION

In general, according to one embodiment, there is provided a display device including: a first substrate including a common electrode disposed over a plurality of pixels, and a pixel electrode disposed in each of the pixels and opposed to the common electrode; a second substrate opposed to the first substrate; a liquid crystal layer disposed between the first substrate and the second substrate; a first alignment film provided on the first substrate and in contact with the liquid crystal layer; and a second alignment film provided on the second substrate and in contact with the liquid crystal layer. The pixel electrode includes a plurality of branch portions extending in a first direction, and a connection portion extending in a second direction intersecting the first direction and connected to the branch portions. The first alignment film and the second alignment film are photo-alignment films, and the first alignment film has an anchoring strength of 1*10⁻³J/m² or less.

According to another embodiment, there is provided a method for manufacturing a display device, the display device including: a first substrate including a plurality of pixel electrodes and a common electrode opposed to the pixel electrodes; a second substrate opposed to the first substrate; a liquid crystal layer disposed between the first substrate and the second substrate; a first alignment film provided on the first substrate and in contact with the liquid crystal layer; and a second alignment film provided on the second substrate and in contact with the liquid crystal layer. Each of the pixel electrodes includes a plurality of branch portions extending in a first direction, and a connection portion extending in a second direction intersecting the first direction and connected to the branch portions. The first alignment film and the second alignment film are photo-alignment films formed by photo-alignment treatment with UV-rays. A total exposure value of UV-rays for forming the first alignment film is different from a total exposure value of UV-rays for forming the second alignment film.

Embodiments will be described hereinafter with reference to the accompanying drawings. The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes and the like, of the respective parts are illustrated schematically in the drawings, rather than as an accurate representation of what is implemented. However, such schematic illustration is merely exemplary, and in no way restricts the interpretation of the invention. In addition, in the specification and drawings, constituent elements which function in the same or a similar manner to those described in connection with preceding drawings are denoted by the same reference sings, and detailed descriptions of them that are considered redundant are omitted unless otherwise necessary.

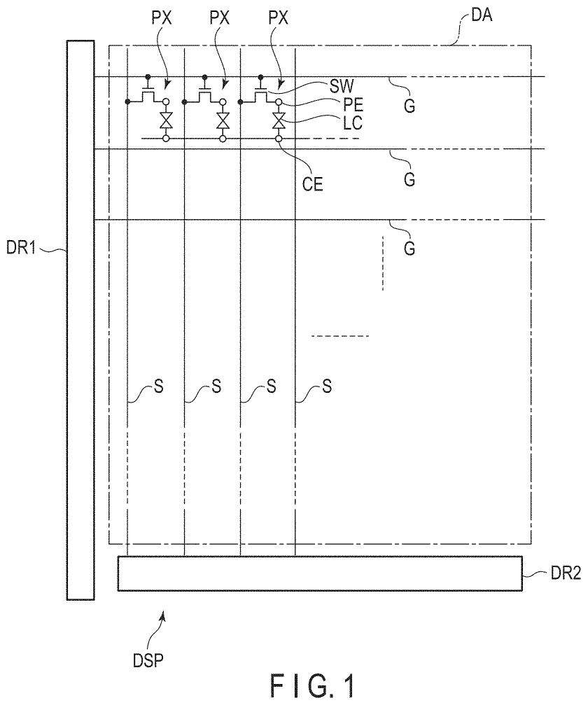

FIG. 1 depicts an example of an equivalent circuit of a display device DSP.

The display device DSP includes a plurality of pixels PX, a plurality of scanning lines G, and a plurality of signal lines S in a display area DA for displaying an image. The scanning lines G and the signal lines S intersect each other. The display device DSP includes a first driver DR1 and a second driver DR2 outside the display area DA. The scanning lines G are electrically connected to the first driver DR1. The signal lines S are electrically connected to the second driver DR2. The first driver DR1 and the second driver DR2 are controlled by a controller.

The pixels PX shown in FIG. 1 are referred to as sub-pixels, color pixels, or the like, and are equivalent to, for example, red pixels that display red, green pixels that display green, blue pixels that display blue, or white pixels that display white. Such pixels PX are each partitioned by, for example, two adjacent scanning lines G and two adjacent signal lines S.

Each pixel PX has a switching element SW, a pixel electrode PE, and a common electrode CE opposed to the pixel electrode PE. The switching element SW is electrically connected to a scanning line G and to a signal line S. The pixel electrode PE is electrically connected to the switching element SW. In other words, the pixel electrode PE is electrically connected to the signal line S via the switching element SW. The common electrode CE is disposed over a plurality of pixels PX. A common voltage is applied to the common electrode CE.

The first driver DR1 supplies a scanning signal to each scanning line G. The second driver DR2 supplies a video signal to each signal line S. The switching element SW, which is electrically connected to the scanning line G supplied with a scanning signal, electrically connects the signal line S to the pixel electrode PE, and consequently a voltage corresponding to a video signal supplied to the signal line S is applied to the pixel electrode PE. A liquid crystal layer LC is driven by an electric field generated between the pixel electrode PE and the common electrode CE.

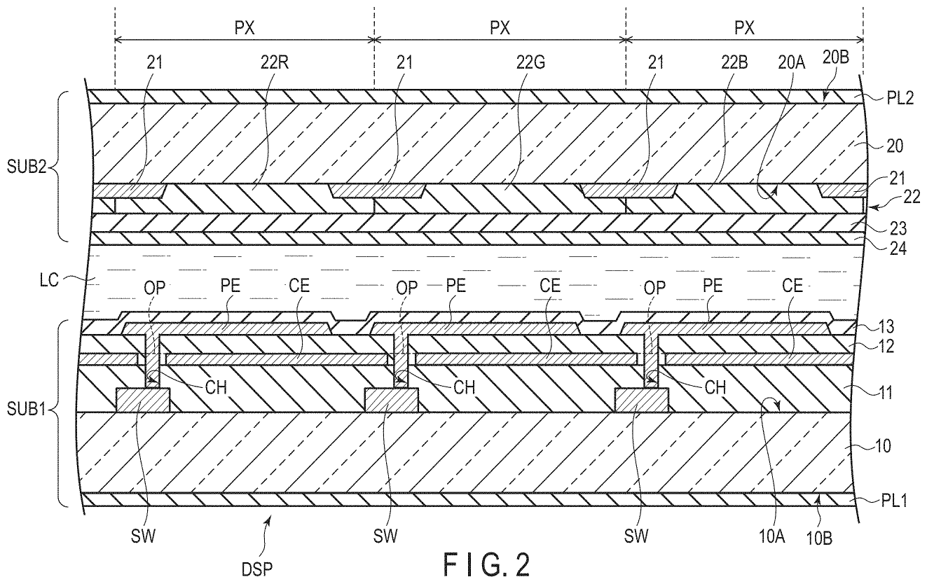

FIG. 2 is a cross-sectional view of an example of the structure of the display device DSP.

The display device DSP includes a first substrate SUB1, a second substrate SUB2, and the liquid crystal layer LC held between the first substrate SUB1 and the second substrate SUB2.

The first substrate SUB1 includes the switching elements SW, the pixel electrodes PE, the common electrode CE, and the like and further includes an insulating base 10, insulating layers 11 and 12, and a first alignment film 13. The first substrate SUB1 also includes the scanning lines G, the signal lines S, the first driver DR1, the second driver DR2, and the like that are shown in FIG. 1. The insulating base 10 is formed of a glass base material, a resin base material, or the like that have light-transmitting properties. The insulating base 10 has a main surface 10A facing the second substrate SUB2, and a main surface 10B located opposite to the main surface 10A.

The switching elements SW are formed on the main surface 10A of the insulating base 10, and are covered with the insulating layer 11. In the example shown in FIG. 2, for convenience in describing the embodiment, the switching elements SW are illustrated in a simplified form as the scanning line G and the signal line S are omitted from FIG. 2. Actually, however, the insulating layer 11 includes a plurality of insulating layers, and the switching elements SW include semiconductor layers and various electrodes that are formed between these insulating layers.

The common electrode CE is formed on the insulating layer 11 and is disposed over the pixels PX. The common electrode CE is covered with the insulating layer 12. The pixel electrode PE of each pixel PX is formed on the insulating layer 12 and is opposed to the common electrode CE across the insulating layer 12. Each pixel electrode PE is electrically connected to the switching element SW through an opening OP of the common electrode CE and a contact hole CH penetrating the insulating layers 11 and 12. The pixel electrode PE and the common electrode CE are transparent electrodes made of a transparent conductive material, such as indium tin oxide (ITO) or indium zinc oxide (IZO).

The first alignment film 13 covers the pixel electrode PE and is in contact with the liquid crystal layer LC. The first alignment film 13 is a photo-alignment film subjected to photo-alignment treatment.

The second substrate SUB2 includes an insulating base 20, light-shielding layers 21, a color filter layer 22, an overcoat layer 23, and a second alignment film 24. The insulating base 20 is formed of a glass base material, a resin base material, or the like that have light-transmitting properties. The insulating base 20 has a main surface 20A facing the first substrate SUB1, and a main surface 20B located opposite to the main surface 20A.

The light-shielding layers 21 are formed on the main surface 20A and are disposed at a boundary between adjacent pixels PX. The color filter layer 22 has a red color filter 22R, a green color filter 22G, and a blue color filter 22B. The overcoat layer 23 covers the color filter layer 22.

The second alignment film 24 covers the overcoat layer 23 and is in contact with the liquid crystal layer LC. The second alignment film 24 is a photo-alignment film subjected to photo-alignment treatment, as the first alignment film 13 is.

A polarizing plate PL1 is bonded to the main surface 10B of the insulating base 10, and a polarizing plate PL2 is bonded to the main surface 20B of the insulating base 20.

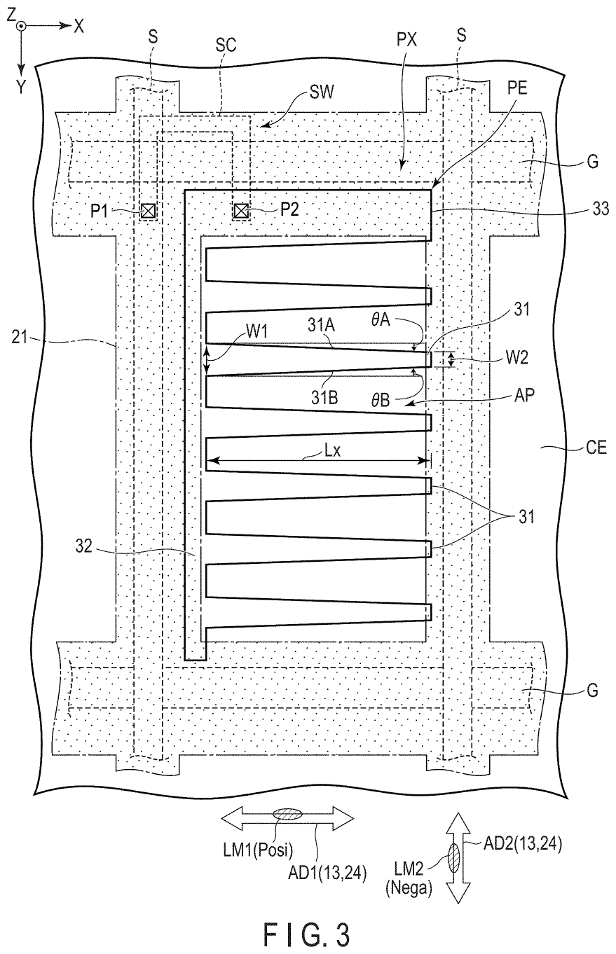

FIG. 3 is a plan view of an example of the pixel PX.

In the example of FIG. 3, a first direction X, a second direction Y, and a third direction Z are perpendicular to each other. They, however, may intersect each other at an angle different from 90°. The first direction X and the second direction Y correspond to directions parallel with the main surfaces of the substrates making up the display device DSP, and the third direction Z corresponds to the thickness direction of the display device DSP.

FIG. 3 shows the switching element SW, the scanning lines G, the signal lines, the common electrode CE, and the pixel electrode PE that are provided on the first substrate SUB1, and also shows the light-shielding layer 21 provided on the second substrate SUB2, the light-shielding layer 21 being indicated by a single-dot chain line.

In the pixel PX, the scanning lines G each extend in the first direction X, the signal lines S each extend in the second direction Y, thus intersecting each scanning line G in a plan view. The switching element SW is placed at an intersection of the scanning line G and the signal line S. In a plan view, the common electrode CE overlaps the scanning lines G, the signal lines S, and the switching element SW. The pixel electrode PE, which is indicated by a continuous line, overlaps the common electrode CE.

The pixel electrode PE has a plurality of branch portions 31 extending in the first direction X, a trunk portion (connection portion) 32 extending in the second direction Y, and a connection portion 33 electrically connected to the switching element SW. The branch portions 31, the trunk portion 32, and the connection portion 33 are formed integrally and are interconnected electrically. Specifically, the branch portions 31 and the connection portion 33 extend from the trunk portion 32 in the same direction along the first direction X. In the example of FIG. 3, the branch portions 31 and the connection portion 33 extend from the trunk portion 32 toward the right-hand side in FIG. 3.

Each branch portion 31 is of, for example, a shape tapering toward a front end on the right-hand side in FIG. 3, and its base connected to the trunk portion 32 has a width W1 larger than a width W2 of the front end. The width mentioned here refers to a length along the second direction Y. A length Lx of the branch portion 31 along the first direction X, for example, ranges from 3 μm to 12 μm. The branch portion 31 has edges 31A and 31B opposed to each other in the second direction Y. The edge 31A is tilted clockwise at an angle θA against an axis along the first direction X. The edge 31B is tilted counterclockwise at an angle PB against an axis along the first direction X. The angle PA and the angle PB are substantially the same angle, which is, for example, 1° or more.

The switching element SW has a semiconductor layer SC. The semiconductor layer SC is connected to the signal line S at a connection position P1, and is connected to the pixel electrode PE at a connection position P2. The contact hole CH and the opening OP at the connection position P2 are not illustrated. In the pixel electrode PE, the connection portion 33 overlaps the connection position P2 and is connected to the semiconductor layer SC. The switching element SW of the example of FIG. 3 is a double gate type in which the semiconductor layer SC intersects the scanning line G at two positions. The switching element SW may be a single gate type in which the semiconductor layer SC intersects the scanning line G at one position.

In a plan view, the light-shielding layer 21 overlaps the scanning lines G, the signal lines S, a part of the pixel electrode PE, and the switching element SW. The light-shielding layer 21 overlaps also the front ends of the branch portions 31 and at least a part of the trunk portion 32 as well. A pixel opening AP surround by the light-shielding layer 21 overlaps the branch portions 31.

The first alignment film 13 and the second alignment film 24 used in the present embodiment are horizontal alignment films each having an alignment regulating force acting along an X-Y plane defined by the first direction X and the second direction Y.

When the liquid crystal layer LC shown in FIG. 2 has positive dielectric constant anisotropy (positive type), an alignment treatment direction AD1 of the first alignment film 13 and second alignment film 24 is parallel with the first direction X. This means that the alignment treatment direction AD1 is parallel with the direction of extension of the branch portions 31. An initial alignment direction of liquid crystal molecules LM1 included in the liquid crystal layer LC is parallel with the first direction X.

When the liquid crystal layer LC shown in FIG. 2 has negative dielectric constant anisotropy (negative type), an alignment treatment direction AD2 of the first alignment film 13 and second alignment film 24 is parallel with the second direction Y. This means that the alignment treatment direction AD2 is a direction intersecting the direction of extension of the branch portions 31, for example, at right angles. An initial alignment direction of liquid crystal molecules LM2 is parallel with the second direction Y.

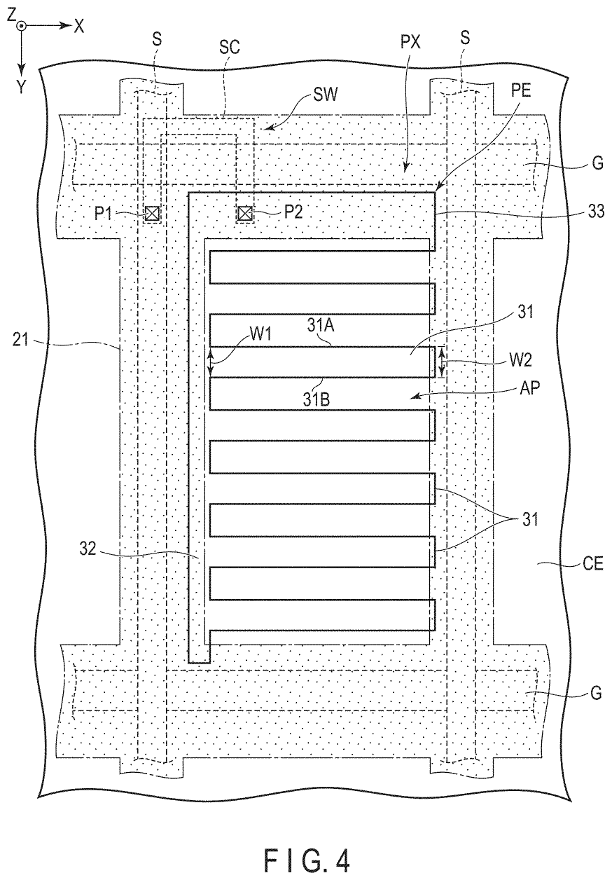

FIG. 4 is a plan view of another example of the pixel PX.

The example shown in FIG. 4 is different from the example shown in FIG. 3 in that the branch portions 31 of the pixel electrode PE are each formed into a rectangular shape extending in the first direction X. In other words, on the branch portion 31, the width W1 of the base connected to the trunk portion 32 is equal to the width W2 of the front end. Both edges 31A and 31B are substantially parallel with the first direction X. It is preferable that an angle equivalent to each of the angles OA and OB shown in FIG. 3 be 0° or more and less than 1°.

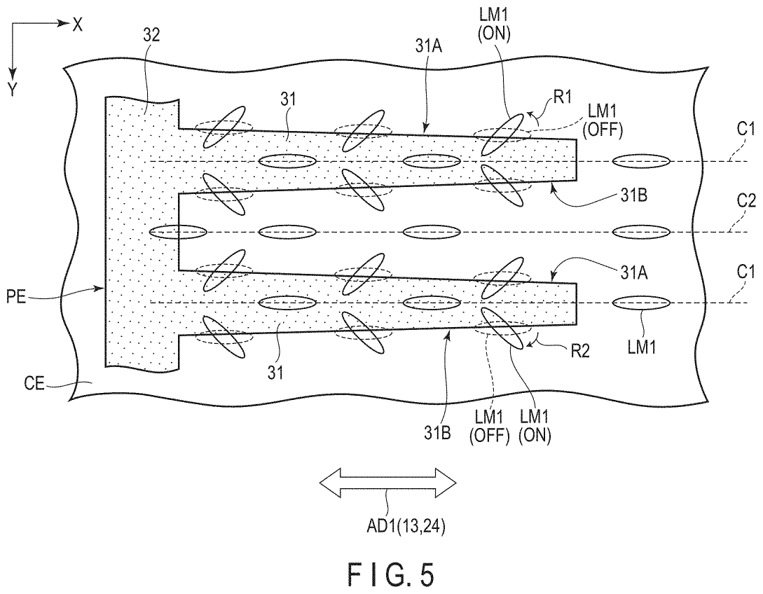

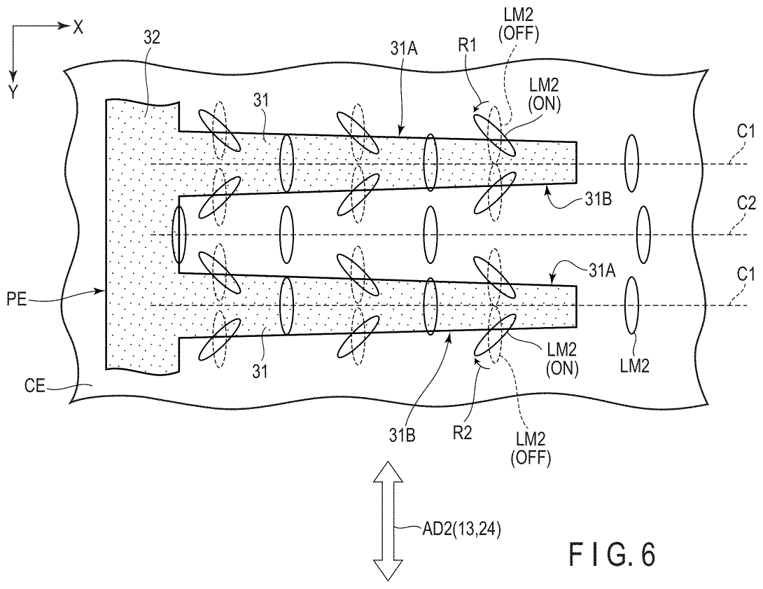

An operation principle will then be described with reference to FIGS. 5 and 6. In each of FIGS. 5 and 6, an aligned state of liquid crystal molecules LM in OFF mode in which no electric field is formed between the pixel electrode PE and the common electrode CE is indicated by dotted lines, and an aligned state of the liquid crystal molecules LM in ON mode in which an electric field is formed between the pixel electrode PE and the common electrode CE is indicated by continuous lines.

FIG. 5 shows an aligned state of the liquid crystal molecules LM1 of the positive type.

The alignment treatment direction AD1 of the first alignment film 13 and second alignment film 24 is parallel with the first direction X. The liquid crystal molecules LM1 in OFF mode are thus in a state of initial alignment along the first direction X, as indicated by dotted lines.

In ON mode, an electric field crossing the edges 31A and 31B is generated on the X-Y plane. The liquid crystal molecules LM1 rotate in such a way as to make their major axes substantially parallel with the electric field. For example, liquid crystal molecules LM1 near the edge 31A rotate in a rotation direction R1, which is the counterclockwise direction. Liquid crystal molecules LM1 near the edge 31B rotate in a rotation direction R2, which is the clockwise direction. This means that at the branch portion 31, the rotation direction of the liquid crystal molecules LM1 on the edge 31A side and the same on the edge 31B side are different from each other.

Meanwhile, in the vicinity of a center line C1 between the edge 31A and the edge 31B of each branch portion 31, liquid crystal molecules LM1 that rotate in the rotation direction R1 and liquid crystal molecules LM1 that rotate in the rotation direction R2 compete with each other. The net result is that the liquid crystal molecules LM1 in such a region hardly rotate in ON mode. In the same manner, in the vicinity of a center line C2 between the edge 31A of one branch portion 31 and the edge 31B of the other branch portion 31, liquid crystal molecules LM1 hardly rotate in ON mode.

FIG. 6 shows an aligned state of the liquid crystal molecules LM2 of the negative type.

The alignment treatment direction AD2 of the first alignment film 13 and second alignment film 24 is parallel with the second direction Y. The liquid crystal molecules LM2 in OFF mode are thus in a state of initial alignment along the second direction Y, as indicated by dotted lines.

The liquid crystal molecules LM2 in ON mode rotate on the X-Y plane in such a way as to make their major axes substantially perpendicular to an electric field. For example, liquid crystal molecules LM2 near the edge 31A rotate in the rotation direction R1, which is the counterclockwise direction. Liquid crystal molecules LM2 near the edge 31B rotate in the rotation direction R2, which is the clockwise direction.

Meanwhile, in the vicinity of the center line C1 of each branch portion 31 and of the center line C2 between branch portions 31 adjacent to each other in the second direction Y, liquid crystal molecules LM2 hardly rotate in ON mode.

In this manner, near the edge 31A of the branch portion 31, the rotation directions of the liquid crystal molecules LM become uniform. Also near the edge 31B, the rotation directions of the liquid crystal molecules LM become uniform. However, the rotation direction of the liquid crystal molecules LM near the edge 31B is reverse to the rotation direction of the liquid crystal molecules LM near the edge 31A. As a result, a region where liquid crystal molecules LM do not rotate is formed periodically along the second direction Y. Thus, in comparison with an ordinary fringe field switching (FFS) mode, a response speed at the time of voltage application increases, and a rise of the liquid crystal molecules LM, which is caused by a vertical electric field, hardly occurs. This allows an improvement in alignment stability.

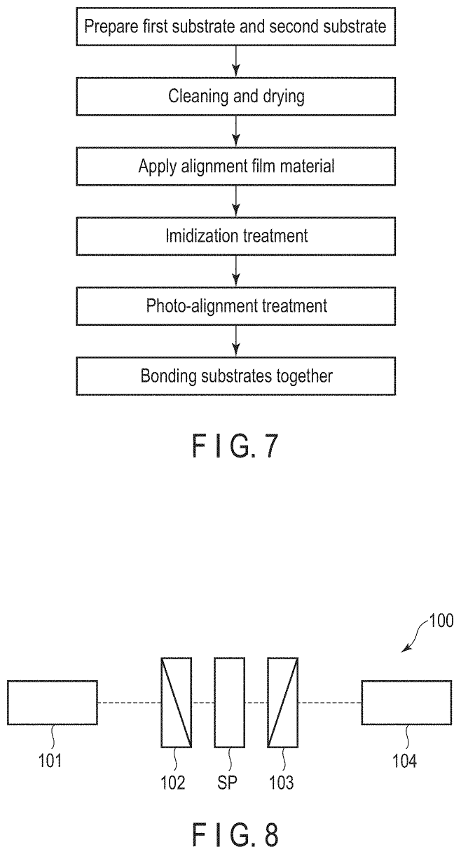

Now an example of a method for manufacturing the above display device DSP will be described with reference to FIG. 7.

First, the first substrate SUB1 and the second substrate SUB2 are prepared through respective manufacturing processes therefor. Afterward, for each of the first substrate SUB1 and the second substrate SUB2, the surface of an underlayer, on which the alignment film is formed, is cleaned and dried by various surface treatment methods, such as a UV/ozone method, an excimer UV method, and an oxygen plasma method.

Subsequently, as an alignment film material, polyamic acid, which is a precursor of the alignment film, is applied by various printing methods, such as screen printing, flexographic printing, and inkjet printing, and is subjected to leveling treatment that makes a film of polyamic acid (precursor) uniform in thickness. Afterward, the precursor is heated at a given temperature to advance an imidization reaction, thereby forming a polyimide film. The polyimide film is then exposed to polarized UV-rays or the like to generate an alignment regulating force on the surface of the polyimide film (photo-alignment treatment). These processes are carried out on each of the first substrate SUB1 and the second substrate SUB2, which creates the first alignment film 13 and the second alignment film 24.

Subsequently, in a state in which a given cell gap is formed between the first substrate SUB1 having the first alignment film 13 and the second substrate SUB2 having the second alignment film 24, the first substrate SUB1 and the second substrate SUB2 are bonded together. A liquid crystal material may be dropped before bonding together the first substrate SUB1 and the second substrate SUB2, or may be injected after bonding together the first substrate SUB1 and the second substrate SUB2. Afterward, an optical film, such as a polarizing plate, is bonded to each of the first substrate SUB1 and the second substrate SUB2, an IC chip, a flexible printed circuit board, and the like are mounted on the first substrate SUB1, and a illumination device and the like are combined. Hence the display device DSP is obtained.

An anchoring strength representing the magnitude of the alignment regulating force will then be described.

The anchoring strength mentioned in the present embodiment is a so-called azimuthal angle anchoring strength, representing the magnitude of an interaction between the alignment film and the liquid crystal molecules. In general, an increment AF of interface free energy when an interface director, which represents the average alignment direction of liquid crystal molecules close to the alignment film surface, is shifted by AT from an interface director (an alignment-facilitating axis) with no deformation stress (elastic force) acting on the liquid crystal layer, can be expressed by the following equation (1).

ΔF=A*sin²(ΔΨ)/2 . . . (1)

A coefficient A in this equation (1) represents the anchoring strength.

The anchoring strength A can be measured by, for example, a torque balance method. According to the torque balance method, samples are prepared, the samples being each created by bonding together two substrates with their respective alignment films formed thereon and sealing in a liquid crystal material between these substrates. A twist angle φ₁ in a plan view of a sample in which a liquid crystal material containing no chiral agent is sealed in is measured and a twist angle φ₂ in plan view of a sample in which a liquid crystal material containing the chiral agent is sealed in is measured as well.

The anchoring strength A is expressed by the following equation (2), using the twist angles φ₁ and φ₂, a twist elastic coefficient K₂ of the liquid crystal material containing the chiral agent, a spiral pitch p of the liquid crystal material containing the chiral agent, and a cell gap d of the sample.

A=2*K₂*(2πd/p−φ₂)/d*sin(φ₂−φ₂) . . . (2)

The anchoring strength A, which is given to the first alignment film 13 and the second alignment film 24 by the photo-alignment treatment described with reference to FIG. 7, can be adjusted, for example, by changing a total exposure value of UV-rays applied on the polyimide film.

In the present embodiment, the anchoring strength of the first alignment film 13 is 1*10⁻³J/m² or less.

The anchoring strength of the first alignment film 13 is equal to or less than the anchoring strength of the second alignment film 24, and should desirably be less than the anchoring strength of the second alignment film 24.

FIG. 8 depicts an example of an optical system 100 that measures the twist angles φ₁ and φ₂.

The optical system 100 includes a visible light source 101, a polarizer 102, an analyzer 103, and a photomultiplier tube (PMT) 104. The visible light source 101, the polarizer 102, the analyzer 103, and the photomultiplier tube 104 are arranged in this order on the same straight line. A sample (evaluation cell) SP is disposed between the polarizer 102 and the analyzer 103.

First, a transmission axis of the polarizer 102 and an absorption axis of the analyzer 103 are aligned with the alignment direction of the alignment film of the sample SP to make the transmission axis and absorption axis substantially parallel with the alignment direction. Next, only the polarizer 102 is rotated to change its angle so that transmitted light intensity is minimized. Next, only the analyzer 103 is rotated to change its angle so that the transmitted light intensity is minimized. The rotation of the polarizer 102 and of the analyzer 103 are repeated in the same manner until their angles converge to constant angles. At the point of convergence to constant angles, a transmission axis rotation angle φα of the polarizer 102 and an absorption axis rotation angle φβ of the analyzer 103 are obtained and used to define a twist angle φ=φβ−φβ.

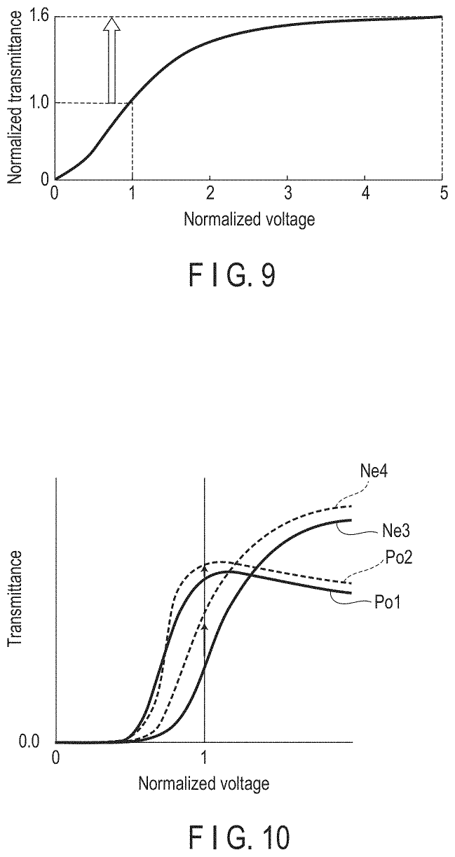

FIG. 9 depicts a relationship between the voltage and the transmittance of the display device DSP in which the liquid crystals of the negative type are used.

The horizontal axis of FIG. 9 represents a voltage applied to the liquid crystal layer LC, and this applied voltage is normalized under a condition that, for example, the maximum value of a commonly used voltage is 1. The vertical axis of FIG. 9 represents the transmittance of the display device DSP, and this transmittance is normalized under a condition that a transmittance measurement for a normalized voltage value of 1 is defined as 1. The display device DSP used to measure the transmittance is a test cell in which the first alignment film 13 and the second alignment film 24 have the equal anchoring strength, respectively.

As indicated in FIG. 9, it has been confirmed that in the display device DSP in which the liquid crystals of the negative type are used, the transmittance tends to increase as the voltage applied to the liquid crystal layer LC increases. In one example, when a voltage about 5 times a commonly used voltage is applied to the liquid crystal layer LC, a transmittance about 1.6 times a normal transmittance is obtained.

A relationship between the anchoring strength of the alignment film and the transmittance of the display device DSP will then be described.

FIG. 10 depicts results of a first simulation.

The horizontal axis represents a normalized voltage applied to the liquid crystal layer LC, and the vertical axis represents the transmittance of the display device DSP. In the first simulation, the anchoring strength of the first alignment film 13 and the anchoring strength of the second alignment film 24 are made equal to each other, and the transmittance for the applied voltage is calculated.

Another condition is set for the first simulation as a condition that the length Lx of the branch portion 31 of the pixel electrode PE be 10 μm. Still another condition is set, according to which main physical property values of the liquid crystal material used are determined as follows. When the liquid crystal material used is the liquid crystal material of the positive type, refractive index anisotropy Δn is 0.13 and dielectric constant anisotropy Δε is 6.3. When the liquid crystal material used is the liquid crystal material of the negative type, the refractive index anisotropy Δn is 0.11 and the dielectric constant anisotropy Δε is −3.9.

These physical property values are an example of physical property values adopted in a simulation. The liquid crystal layer LC in the display device DSP of the present embodiment is not limited to the liquid crystal layer LC made of the liquid crystal material having the physical property values described above, and the liquid crystal layer LC may be formed using a liquid crystal material having other physical property values.

The liquid crystal material of the positive type is used in a case 1, where the anchoring strength of the first alignment film 13 and of the second alignment film 24 is determined to be 1*10⁻²J/m². A simulation result of the case 1 is shown as Po1.

The liquid crystal material of the positive type is used in a case 2, where the anchoring strength of the first alignment film 13 and of the second alignment film 24 is determined to be 1*10⁻³J/m². A simulation result of the case 2 is shown as Po2.

The liquid crystal material of the negative type is used in a case 3, where the anchoring strength of the first alignment film 13 and of the second alignment film 24 is determined to be 1*10⁻²J/m². A simulation result of the case 3 is shown as Ne3.

The liquid crystal material of the negative type is used in a case 4, where the anchoring strength of the first alignment film 13 and of the second alignment film 24 is determined to be 1*10⁻³J/m². A simulation result of the case 4 is shown as Ne4.

Paying attention to the simulation results Po1 and Po2 in the case of the normalized voltage being 1 has led to a confirmation that reduction of the anchoring strength of the first alignment film 13 and the second alignment film 24 by 90% results in about 8% increase in the transmittance.

Paying attention to the simulation results Ne3 and Ne4 in the case of the normalized voltage being 1 has led to a confirmation that reduction of the anchoring strength of the first alignment film 13 and the second alignment film 24 by 90% results in about 74% increase in the transmittance.

In this manner, according to the results of the first simulation, it has been confirmed that in both cases where the liquid crystal material of the positive type and the liquid crystal material of the negative type are used respectively, using an alignment film with a low anchoring strength of 1*10⁻³J/m² or less (case 2 and case 4) allows an improvement in the transmittance of the display device DSP, compared to cases of using an alignment film with a high anchoring strength (case 1 and case 3).

In addition, it has also been confirmed that a degree of increase in the transmittance in the cases of using the liquid crystal material of the negative type (a difference between the transmittance in the case 3 and the transmittance in the case 4) is larger than a degree of increase in the transmittance in the cases of using the liquid crystal material of the positive type (a difference between the transmittance in the case 1 and the transmittance in the case 2). This leads to a conclusion that from the viewpoint of improving the transmittance, using the liquid crystal material of the negative type is preferable in liquid crystal material selection, and using the alignment film with a low anchoring strength is effective in alignment film selection.

In the cases where the liquid crystal material of the negative type is used, comparing applied voltages that make the transmittance in the case 3 and the transmittance in the case 4 equal to each other has led to a confirmation that the applied voltage in the case 4 is shifted toward the lower voltage side relative to the applied voltage in the case 3. This means that because an applied voltage required for obtaining a given transmittance drops, low-voltage driving becomes possible.

The inventor has conducted a similar simulation using the dielectric constant anisotropy Δε is of the liquid crystal material of the negative type as a parameter, the dielectric constant anisotropy Δε being one of conditions for the first simulation, and has confirmed a transmittance increase, as confirmed in the case 3, when the dielectric constant anisotropy As is −5.0 or more.

By determining the viscosity of the liquid crystal material to be small or the dielectric constant anisotropy As to be large, a response speed at the time of voltage application can be increased. In addition, by determining the dielectric constant anisotropy As to be large, a driving voltage can be lowered. It should be noted, however, that increasing the dielectric constant anisotropy As leads to an increase in the viscosity. An increase in the viscosity could cause a drop in the response speed and an increase in the driving voltage.

It is therefore desirable from the viewpoint of a higher response speed and a lower driving voltage that the dielectric constant anisotropy Δε be set |Δε|≤5, and more desirably, be set |Δε|<4.5.

Next, with attention paid to the liquid crystal material of the negative type, the transmittance in a case of using an alignment film with an anchoring strength lower than the anchoring strength in the case 4 has been calculated.

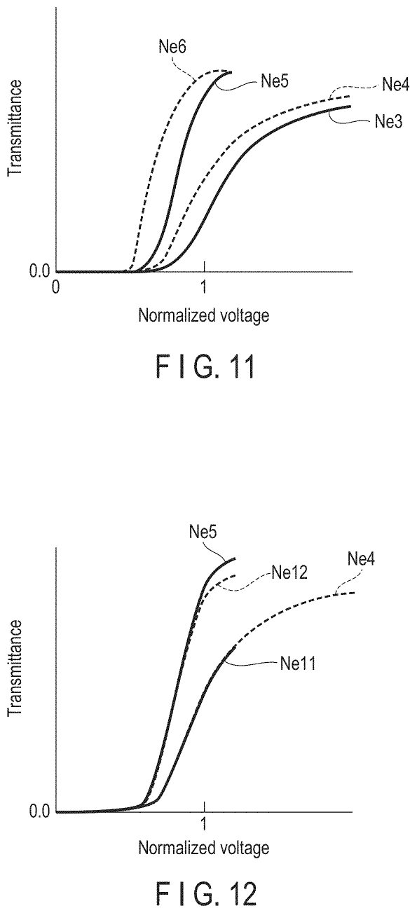

FIG. 11 depicts results of the first simulation in which the liquid crystal material of the negative type is used.

The horizontal axis represents a normalized voltage applied to the liquid crystal layer LC, and the vertical axis represents the transmittance of the display device DSP.

The liquid crystal material of the negative type is used in a case 5, where the anchoring strength of the first alignment film 13 and of the second alignment film 24 is determined to be 5*10⁻⁴J/m². A simulation result of the case 5 is shown as Ne5.

The liquid crystal material of the negative type is used in a case 6, where the anchoring strength of the first alignment film 13 and of the second alignment film 24 is determined to be 1*10⁻⁴J/m². A simulation result of the case 6 is shown as Ne6. Conditions other than anchoring strength setting are the same as the conditions described above.

The simulation results Ne5 and Ne6 demonstrate that, compared with the simulation results Ne3 and Ne4, the driving voltage is further reduced as the transmittance is increased. However, a case where the anchoring strength of the first alignment film 13 is 5*10⁻⁴J/m² or less raises a concern that the alignment stability of liquid crystal molecules in ON mode may not be sufficiently maintained.

In the present embodiment, as described above, the rotation direction of liquid crystal molecules on the edge 31A of the branch portion 31 and the same on the edge 31B are different from each other, and this difference achieves a higher response speed and enhanced alignment stability. However, in a case where the anchoring strength of the first alignment film 13 is decreased extremely, a pixel electrode with the length Lx of the branch portion 31 being 9 μm or more poses a problem that the rotation directions of the liquid crystal molecules tend to become uniform on the edge 31A and on the edge 31B, which makes maintaining the alignment stability difficult. It is desirable, for this reason, that the anchoring strength of the first alignment film 13 be more than 5*10⁻⁴J/m².

With regard to the case 5 and the case 6, the inventor has conducted a similar simulation using the length Lx of the branch portion 31 as a parameter, the length Lx being one of conditions for the first simulation, and has confirmed that in a case of the length Lx being 4.0 μm or more and 6.5 μm or less (about 5 μm in one example), the rotation direction of liquid crystal molecules on the edge 31A of the branch portion 31 and the same on the edge 31B are different from each other, as in the case 4, to improve the alignment stability. In addition, when the length Lx is 5.5 μm or less, a lower limit value of allowable anchoring strength can be further reduced.

The rotation direction of liquid crystal molecules in a region along an edge of the branch portion 31 depends on the rotation direction of the liquid crystal molecules in the vicinity of an intersection between the edge and the trunk portion 32 and of an intersection between the edge and the front end of the branch portion 31. As the length Lx of the branch portion 31 becomes shorter, the front end of the branch portion 31 approaches the trunk portion 32, in which case, because of the fact stated above, the rotation directions of liquid crystal molecules in the region along the edge tend to become uniform, which improves the alignment stability.

From the viewpoint of alignment stability and higher response speed, therefore, under a condition of the length Lx being reduced to about 5 μm, the anchoring strength of the first alignment film 13 should preferably be 1*10⁻⁴J/m² or more, and more preferably, be 5*10⁻⁴J/m² or more.

FIG. 12 depicts results of a second simulation.

The horizontal axis represents a normalized voltage applied to the liquid crystal layer LC, and the vertical axis represents the transmittance of the display device DSP. In the second simulation, the anchoring strength of the first alignment film 13 is determined to be less than the anchoring strength of the second alignment film 24, and the transmittance for the applied voltage is calculated.

Other conditions set for the second simulation include a condition that the length Lx of the branch portion 31 of the pixel electrode PE is 10 μm, a condition that the refractive index anisotropy An of the liquid crystal material of the negative type used in the simulation is 0.11, and a condition that the dielectric constant anisotropy Δε is −3.9.

In a case 11, the anchoring strength of the first alignment film 13 is determined to be 1*10⁻³J/m², and the anchoring strength of the second alignment film 24 is determined to be 1*10⁻²J/m². A simulation result of the case 11 is shown as Ne11.

In a case 12, the anchoring strength of the first alignment film 13 is determined to be 5*10⁻⁴J/m², and the anchoring strength of the second alignment film 24 is determined to be 1*10⁻²J/m². A simulation result of the case 12 is shown as Ne12.

In FIG. 12, the simulation result Ne4 of the case 4 and the simulation result Ne5 of the case 5 are shown as reference data.

Comparing the case 4 with the case 11 reveals that the anchoring strength of the first alignment film 13 is identical in both cases, but the anchoring strength of the second alignment film 24 is different between both cases. The simulation results Ne4 and Nell of these cases have been confirmed as results almost equal to each other.

Likewise, comparing the case 5 with the case 12 reveals that the anchoring strength of the first alignment film 13 is identical in both cases, but the anchoring strength of the second alignment film 24 is different between both cases. The simulation results Ne5 and Ne12 of these cases have also been confirmed as results almost equal to each other.

This means that when the anchoring strength of the first alignment film 13 is identical in both cases, equal simulation results can be obtained hardly depending on the anchoring strength of the second alignment film 24.

Next, test cells corresponding to the above cases have been created, and an experiment for measuring the transmittance for the applied voltage has been conducted.

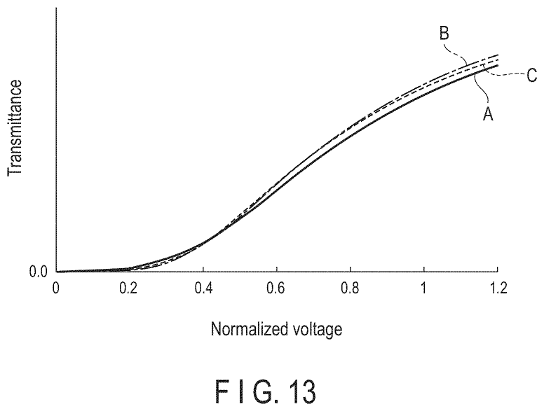

FIG. 13 depicts experimental results.

The horizontal axis represents a normalized voltage applied to the liquid crystal layer LC, and the vertical axis represents the transmittance of the display device DSP. A in FIG. 13 indicates an experimental result of a test cell of a comparative example, B in FIG. 13 indicates an experimental result of a test cell of a first example, and C in FIG. 13 indicates an experimental result of a test cell of a second example.

The comparative example corresponds to the case 3. In the test cell of the comparative example, the anchoring strength of the first alignment film 13 and that of the second alignment film 24 are substantially the same anchoring strength, which is about 1*10⁻²J/m².

The first example and the second example each correspond to the case 11. However, the test cell of the first example and the test cell of the second example are different in manufacturing method from each other. The test cell of the first example and the test cell of the second example are each manufactured under a condition that a total exposure value of UV-rays for forming the first alignment film 13 is different from a total exposure value of UV-rays for forming the second alignment film 24.

More specifically, in the test cell of the first example, the total exposure value of UV-rays for forming the first alignment film 13 is less than the total exposure value of UV-rays for forming the second alignment film 24.

In the test cell of the second example, the total exposure value of UV-rays for forming the first alignment film 13 is more than the total exposure value of UV-rays for forming the second alignment film 24.

In the test cells manufactured in this manner, to ensure that the test cells correspond to the case 11, the anchoring strength of the first alignment film 13 is made less than the anchoring strength of the second alignment film 24. In one example, the anchoring strength of the first alignment film 13 is more than 5*10⁻⁴J/m² and is equal to or less than 1*10⁻³J/m². The anchoring strength of the second alignment film 24 is about 1*10⁻²J/m².

The experimental results A, B, and C demonstrate that the transmittance is improved in the first and second examples to become higher than the transmittance in the comparative example.

As described above, according to the present embodiment, a display device capable of improving display quality and a method for manufacturing the display device can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The display device DSP of the present embodiment is not limited to a transmissive type having a transmissive display function of selectively transmitting light from the back surface side of the first substrate SUB1 to display an image, and may be a reflective type having a reflective display function of selectively reflecting light from the front surface side of the second substrate SUB2 to display an image, or a transflective type having a transmissive display function and a reflective display function.

In the present embodiment, the display device DSP capable of display mode using a lateral electric field along the main surface of the substrate has been described, but the present invention is not limited to this display device DSP, and may provide any one of the following display devices DSP: a display device DSP capable of display mode using a vertical electric field along a normal line to the main surface of the substrate, a display device capable of display mode using an inclined electric field inclined slanted against the main surface of the substrate, and a display device DSP capable of display mode using a proper combination of the lateral electric field, the vertical electric field, and the inclined electric field. The main surface of the substrate refers to a surface parallel with the X-Y plane.

What is claimed is:

1. A display device comprising:
a first substrate including a common electrode disposed over a plurality of pixels, and a pixel electrode disposed in each of the pixels and opposed to the common electrode;
a second substrate opposed to the first substrate;
a liquid crystal layer disposed between the first substrate and the second substrate;
a first alignment film provided on the first substrate and being in contact with the liquid crystal layer; and
a second alignment film provided on the second substrate and being in contact with the liquid crystal layer, wherein
the pixel electrode includes:
a plurality of branch portions extending in a first direction; and
a connection portion extending in a second direction intersecting the first direction and connected to the branch portions,
the first alignment film and the second alignment film are photo-alignment films, and
the first alignment film has an anchoring strength of 1*10⁻³J/m² or less.

2. The display device according to claim 1, wherein
an anchoring strength of the first alignment film is more than 5*10⁻⁴J/m².

3. The display device according to claim 2, wherein
an anchoring strength of the first alignment film is less than an anchoring strength of the second alignment film.

4. The display device according to claim 1, wherein
the liquid crystal layer has negative dielectric constant anisotropy, and wherein
liquid crystal molecules of the liquid crystal layer are in a state of initial alignment in the second direction.

5. The display device according to claim 2, wherein
a length of each of the branch portions is 9 pm or more.

6. The display device according to claim 1, wherein
a length of each of the branch portions is 4.0 μm or more and 6.5 μm or less, and wherein
an anchoring strength of the first alignment film is more than 1*10⁻⁴J/m².

7. A method for manufacturing a display device, the display device comprising:
a first substrate including a plurality of pixel electrodes and a common electrode opposed to the pixel electrodes;
a second substrate opposed to the first substrate;
a liquid crystal layer disposed between the first substrate and the second substrate;
a first alignment film provided on the first substrate and being in contact with the liquid crystal layer; and
a second alignment film provided on the second substrate and being in contact with the liquid crystal layer, wherein
each of the pixel electrodes includes:
a plurality of branch portions extending in a first direction; and
a connection portion extending in a second direction intersecting the first direction and connected to the branch portions,
the first alignment film and the second alignment film are photo-alignment films formed by photo-alignment treatment with UV-rays, and
a total exposure value of UV-rays for forming the first alignment film is different from a total exposure value of UV-rays for forming the second alignment film.

8. The method for manufacturing the display device according to claim 7, wherein
an anchoring strength of the first alignment film is more than 5*10⁻⁴J/m² and is equal to or less than 1*10⁻³J/m².

9. The method for manufacturing the display device according to claim 8, wherein
an anchoring strength of the first alignment film is less than an anchoring strength of the second alignment film.

10. The method for manufacturing the display device according to claim 7, wherein
a total exposure value of UV-rays for forming the first alignment film is less than a total exposure value of UV-rays forming the second alignment film.
